(19) United States
(12) Patent Application Publication
(10) Pub. No.: US 2013/0015835 A1
(43) Pub. Date: Jan. 17, 2013

(54) RIPPLE FREE BAND-GAP VOLTAGE GENERATOR IMPLEMENTING A CHOPPING TECHNIQUE AND RELATIVE METHOD

(71) Applicants: Stefano CORRADI, Siracusa (IT); Domenico CRISTAUDO, Tremestieri Etneo (IT); Daniele BATTAGLIA, San Gregorio di Catania (CT) (IT)

(72) Inventors: Stefano CORRADI, Siracusa (IT); Domenico CRISTAUDO, Tremestieri Etneo (IT); Daniele BATTAGLIA, San Gregorio di Catania (CT) (IT)

(73) Assignee: STMicroelectronics, S.r.l., Agrate Brianza (MB) (IT)

(21) Appl. No.: 13/546,446

(22) Filed: Jul. 11, 2012

(30) Foreign Application Priority Data
Jul. 15, 2011 (IT) MI2011A001319

(51) Int. Cl. G05F 3/02

(52) U.S. Cl. 323/313

(57) ABSTRACT

A band-gap reference voltage generator for generating a stable band-gap reference voltage including a chopped band-gap circuit, a first sample and hold circuit coupled to the chopped band-gap circuit, a second sample and hold circuit coupled to the chopped band-gap circuit, and an output circuit coupled to the first and second sample and hold circuits for generating the stable band-gap reference voltage.

### RELATED APPLICATION

This application is a translation of and claims the priority benefit of Italian patent application number MI2011A001319, filed on Jul. 15, 2011, entitled Ripple Free Band-Gap Voltage Generator Implementing A Chopping Technique And Relative Method, which is hereby incorporated by reference to the maximum extent allowable by law.

### TECHNICAL FIELD

This invention relates to electronic circuits for generating a stable reference voltage and more particularly to a novel architecture of a band-gap voltage generator and a relative method of generating a stable and ripple free chopper amplified band-gap reference voltage.

### BACKGROUND

Integrated circuits, and other electronic circuits, often require operating voltages that are stable over process, voltage, and temperature variations. Stable reference voltages are provided by band-gap reference voltage generators.

A topology of a classic band-gap reference voltage generator is depicted in FIG. 1. The two transistors have different sectional areas, A1 and A2, and are crossed by a same current, thus the base-emitter voltages of the two transistors are different. According to a well-known technique, an operational amplifier replicates on the node A the same voltage on the node B to force through a resistor R1 a current I_{PTAT} proportional to the absolute temperature T of the circuit. The current I_{PTAT} is forced throughout the resistor R2, thus the voltage drop V_{PTAT} on the third resistor R3, which is identical to the resistor R2, is proportional to the absolute temperature T of the circuit. The sum between the voltage V_{PTAT} and the voltage V_{BE1} gives a substantially stable band-gap voltage reference.

A drawback of this prior solution is that the operational amplifier has a fluctuating offset voltage that causes unacceptable fluctuations of the output voltage Vref over process spread and temperature variations.

A known technique of reducing fluctuations induced by the offset voltage of the operational amplifier is schematically shown in FIG. 2. The second mixer, nested into the error amplifier, modulates the offset voltage of the error amplifier with a modulating carrier f_{chop} smaller than the bandwidth of the error amplifier, as shown in FIG. 3. The first mixer keeps the loops sign for proper stability following the pace of the second modulator. The up-converted V_{OFFSET} adds a ripple at V_{REF} whose frequency is f_{CHOP} and its amplitude is proportional to the offset of the operational amplifier. In order to avoid these oscillations, the U.S. Pat. No. 6,462,612 in the name of Intel Corporation discloses a band-gap reference voltage generator (FIG. 5) having a low-pass filter that blocks the high frequency modulated component of the voltage generated by the demodulator, thus providing an attenuation of the ripple at the output reference voltage VOUT.

Unfortunately, the low-pass filter is a RC filter that requires a very large silicon area in order to fix a low cut-off frequency, for filtering out efficiently the ripple caused by the chopping technique. Silicon area requirements of the low-pass filter could be reduced by increasing the frequency f_{chop}, because this would allow realizing a smaller capacitor. Unfortunately, increasing the frequency f_{chop} would force the use of expensive high-frequency operational amplifiers and to increase current consumption.

### SUMMARY OF THE INVENTION

Deep studies carried out by the applicant in order to realize a band-gap reference voltage generator led to the conclusion that the above remarked limitations could be overcome by realizing an architecture of band-gap reference voltage generator that exploits a chopping technique without using a low-pass filter, which is commonly considered an essential and unavoidable component for obtaining stable band-gap reference voltages.

The applicant noticed that chopped band-gap circuits, which are the core of band-gap voltage generators that implement a chopping technique, generate a substantially square-wave oscillating voltage and realized that this characteristic gives the possibility of devising an architecture of a band-gap reference voltage generator that does not include a low-pass filter. Indeed, the square-wave oscillating voltage is adapted to be sampled and thus a stable reference voltage may be obtained by sampling the oscillating voltage and combining the samples thereof.

Starting from a classic chopped band-gap circuit that generates a substantially square-wave oscillating voltage, according to an innovative aspect a stable band-gap reference voltage may be obtained by sampling the oscillating voltage when it is greater than its average value and when it is smaller than its average value, then averaging or even summing together the two samples.

A novel architecture of a band-gap reference voltage generator, implementing a relative method, comprises:

a chopped band-gap circuit including at least an operational amplifier, said chopped band-gap circuit being adapted to generate a substantially square-wave oscillating voltage with a frequency determined by a square-wave chopping carrier of the chopped band-gap circuit,

a first autozeroed sample and hold circuit connected to the chopped band-gap circuit such to be input with said square-wave oscillating voltage, being adapted to output samples taken when the square-wave oscillating voltage is greater than its average value;

a second autozeroed sample and hold circuit connected to the chopped band-gap circuit such to be input with said square-wave oscillating voltage, being adapted to output samples taken when the square-wave oscillating voltage is smaller than its average value;

an output block input with the samples taken by said first and second sample and hold circuits, adapted to generate said stable band-gap reference voltage as the average or the sum thereof.

Other embodiments are defined in the annexed dependent claims.

The claims as filed are an integral part of this description and are incorporated herein by reference.

### BRIEF DESCRIPTION OF THE DRAWINGS

FIG. 1 depicts the topology of a classic band-gap reference voltage generator.

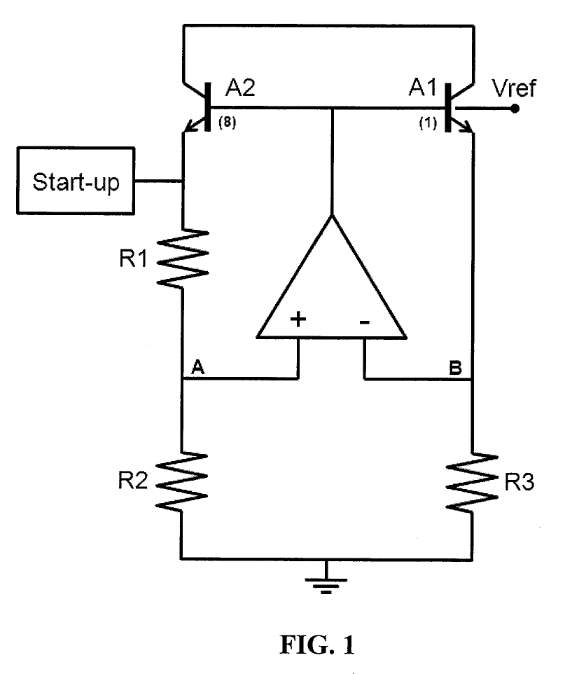

FIG. 2 basically illustrates another classic band-gap reference voltage generator using a chopping technique.

FIG. 3 is an exemplary frequency spectrum of the fluctuating offset of the operational amplifier of FIG. 2 at the chopping carrier.

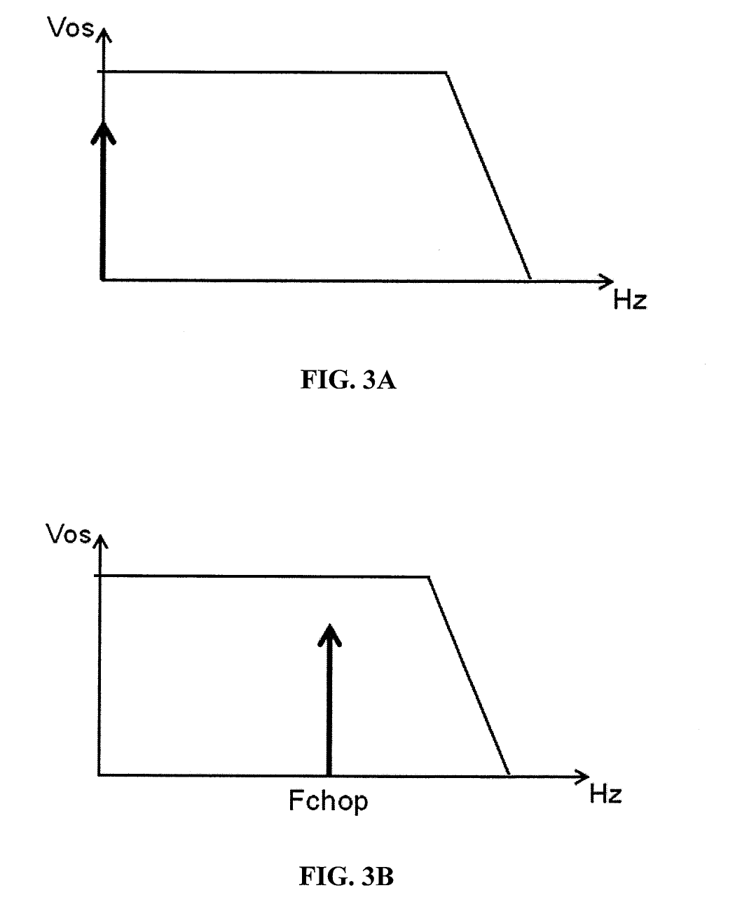

FIG. 4 is an exemplary time diagram of the output reference voltage generated by the generator of FIG. 2.

FIG. 5 is a band-gap reference voltage generator disclosed in the prior patent U.S. Pat. No. 6,462,612.

FIG. 6 depicts a novel band-gap reference voltage generator in which the circuit for filtering the effects of the offset voltage is highlighted.

FIG. 7 is a sample graph of amplitude vs. frequency characteristics of BLOCK1 in FIG. 6.

### DETAILED DESCRIPTION

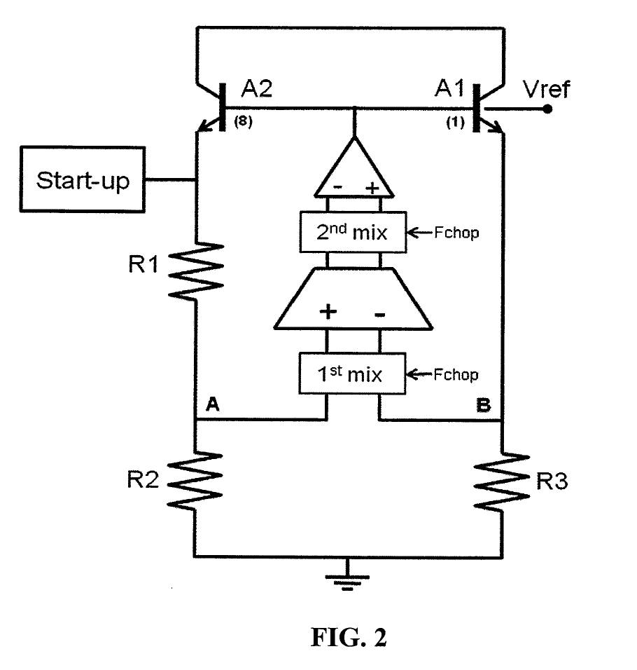

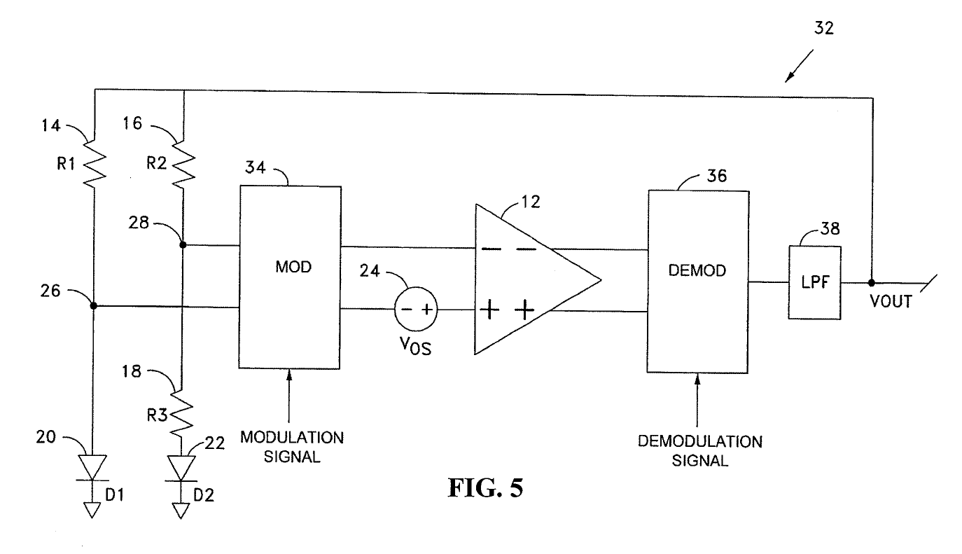

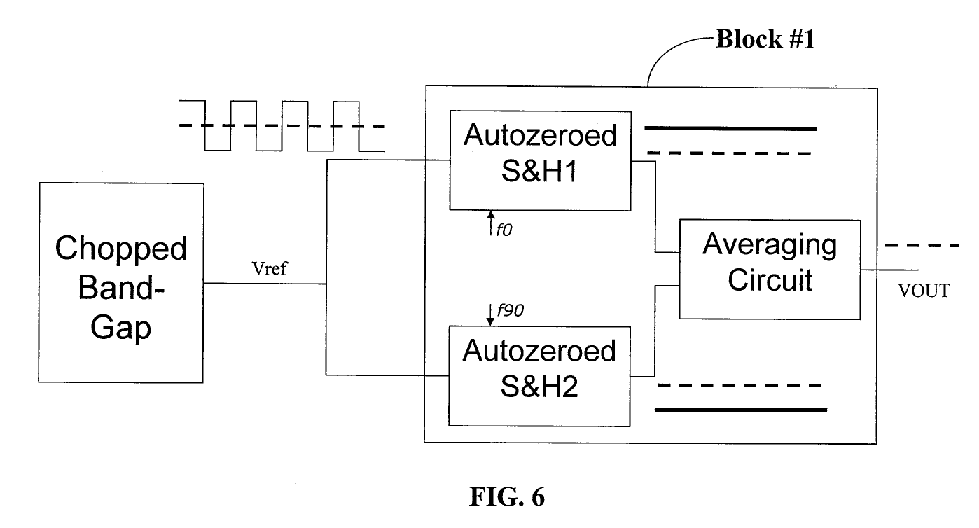

The herein proposed circuit for substantially removing the high frequency modulated component from the voltage generated by the demodulator in the proposed voltage generator is shown in FIG. 6. The block CHOPPED BAND-GAP represents all the blocks of any band-gap voltage generator, such as, for example, the blocks shown in FIG. 5 upstream to the low-pass filter LPF or the circuit shown in FIG. 2. According to the proposed architecture, the voltage Vref is sampled with a first sampling signal f₀ and with a second sampling signal f₉₀, in phase opposition one with respect to the other and both at the same frequency of the chopping carrier f_{chop}.

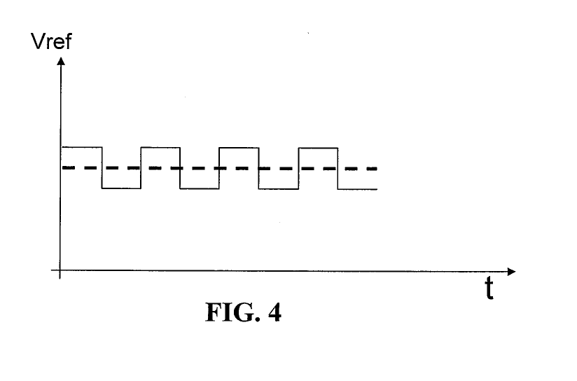

The novel architecture exploits the fact that the voltage Vref generated by the block CHOPPED BAND-GAP is substantially a square-wave signal oscillating around an average value that corresponds to the desired band-gap reference voltage, as shown in FIG. 4. The amplitude of the oscillations is determined by the offset voltage of the operational amplifier OpAmp. Instead of using a silicon area consuming the low-pass filter, it is possible to obtain the average value by sampling the voltage Vref with a first sampling signal f₀ and with a second sampling signal f₉₀, in phase opposition one with respect to the other, and by adding the two samples. The signals f₀ and f₉₀ are outphased with respect to the chopping carrier f_{chop} to determine the sampling instants when the voltage Vref is substantially constant between consecutive leading/trailing edges.

More specifically, the novel band-gap reference voltage generator has a first sample and hold circuit S&H1 that samples the voltage Vref with a sampling signal f₀, having the same frequency of the chopping carrier f_{chop}, and a second sample and hold circuit S&H2 that samples the voltage Vref with a sampling signal f₉₀, in phase opposition with the sampling signal f₀. An AVERAGING CIRCUIT generates an average or a sum of the last samples taken by the two sample and hold circuits and generates the desired output reference voltage.

Since the voltage Vref is a square-wave and assuming that fluctuations of the offset voltage are much slower than the chopping carrier, it may be fairly assumed that the two samples are at the same distance but from opposite sides from the average voltage. Thus, by averaging them together, the desired stable voltage is obtained.

According to an alternative embodiment, the two samples are summed together to generate the stable voltage.

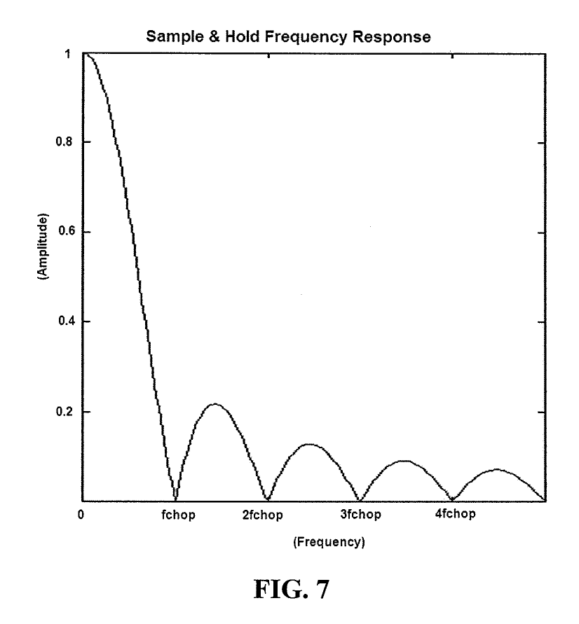

Block1 acts like a notch filter tuned at f_{CHOP} and its multiples, so that any fluctuation or inaccuracy in the chopper clock frequency are automatically compensated because the filter tracks the chopper frequency anyway (FIG. 7).

For this reason, the herein proposed architecture need not be a high-precision oscillator for generating the chopping carrier.

As an alternative, the sampling signals f₀ and f₉₀ may both have a same submultiple frequency of the chopping carrier f_{chop}, provided that they are outphased such to sample the voltage Vref when it is greater and smaller, respectively, of its average value.

Differently from prior architectures that use a low-pass filter, the novel architecture extracts the average value of the voltage Vref with sample and hold circuits, that occupy a reduced silicon area and have a reduced current consumption.

The sample and hold circuits and the adder may be easily realized in integrated form with all other components of a chopped band-gap reference voltage generator.

The novel band-gap reference voltage generator may be included in any electronic appliance, such as for example mobile phones with AMOLED screen.

It will be apparent to those skilled in the art, therefore, that various modifications and variations can be made to the invention without departing from the spirit or scope of the invention. Thus, it is intended that the present invention covers the modifications and variations of this invention provided they come within the scope of the appended claims.

We claim:

1. A band-gap reference voltage generator adapted to generate a stable band-gap reference voltage, comprising:
a chopped band-gap circuit including at least an operational amplifier, said chopped band-gap circuit being adapted to generate a substantially square-wave oscillating voltage with a frequency determined by a square-wave chopping carrier of the chopped band-gap circuit,
characterized in that the band-gap reference voltage generator comprises:
a first sample and hold circuit connected to the chopped band-gap circuit to be input with said square-wave oscillating voltage, being adapted to output samples taken when the square-wave oscillating voltage is greater than its average value;
a second sample and hold circuit connected to the chopped band-gap circuit to be input with said square-wave oscillating voltage, being adapted to output samples taken when the square-wave oscillating voltage is smaller than its average value; and
an output block circuit input with the samples taken by said first and second sample and hold circuits, adapted to generate said stable band-gap reference voltage as either the average or the sum thereof.

2. The band-gap reference voltage generator of claim 1, wherein said first and second sample and hold circuits are clocked with respective sampling signals first and second having the same frequency of said chopping carrier and being outphased in respect to the chopping carrier to cause the first and second sample and hold circuits to take samples when the oscillating voltage is greater and smaller, respectively, than its average value.

3. The band-gap reference voltage generator of claim 1, wherein said first and second sample and hold circuits are clocked with respective sampling signals first and second having submultiple frequency of said chopping carrier and being outphased between them as to cause the first and second sample and hold circuits to take samples when the oscillating voltage is greater and smaller, respectively, than its average value.

4. The band-gap reference voltage generator of claim 2, wherein said oscillating voltage is substantially a square-wave at the frequency of the chopping carrier, and said sampling signals first and second are outphased in respect to said chopping carrier to cause the first and second sample and hold circuits to take samples of said oscillating voltage when it assumes a substantially constant value.

5. The band-gap reference voltage generator of claim 1, wherein each of said first and second sample and hold circuits are adapted to output a moving average of said oscillating voltage.

6. The band-gap reference voltage generator of claim 1, wherein said chopped band-gap circuit comprises:
a band-gap circuit adapted to generate a low band-gap voltage;
a modulator controlled by said square-wave chopping carrier and connected downstream from said band-gap circuit to be input with said low band-gap voltage, adapted to generate a square-wave modulated low band-gap voltage;
an error amplifier connected to be adapted to amplify the square-wave modulated low band-gap voltage; and
a demodulator controlled by said square-wave chopping carrier and connected downstream from said error amplifier, adapted to generate said square-wave oscillating voltage.

7. An electronic device comprising the band-gap reference voltage generator of claim 1.

8. An AMOLED screen comprising the band-gap reference voltage generator of claim 1.

9. A method of generating a stable band-gap reference voltage, comprising:
generating a low band-gap voltage;
modulating said low band-gap voltage with a square-wave chopping carrier, generating a square-wave modulated low band-gap voltage;
amplifying said square-wave modulated low band-gap voltage, generating an amplified replica thereof;
demodulating said amplified replica with said square-wave chopping carrier, generating a substantially square-wave oscillating voltage;
sampling said square-wave oscillating voltage when the square-wave oscillating voltage is greater than its average value, generating a first stream of samples;
sampling said square-wave oscillating voltage when the square-wave oscillating voltage is smaller than its average value, generating a second stream of samples; and
generating samples of said stable and amplified band-gap reference voltage as a combination of samples of the first stream and samples of the second stream.

10. The method of claim 9, wherein the combination comprises either an average or a sum therebetween.

11. A band-gap reference voltage generator for generating a stable band-gap reference voltage, comprising:
a chopped band-gap circuit;
a first sample and hold circuit coupled to the chopped band-gap circuit;
a second sample and hold circuit coupled to the chopped band-gap; and
an output circuit coupled to the first and second sample and hold circuits for generating the stable band-gap reference voltage.

12. The band-gap reference voltage generator of claim 11, wherein the sample and hold circuits are clocked with respective sampling signals having the same frequency.

13. The band-gap reference voltage generator of claim 11, wherein the sample and hold circuits are clocked with respective sampling signals having different phases.

14. The band-gap reference voltage generator of claim 11, wherein the output of the chopped band-gap circuit is an oscillating voltage.

15. The band-gap reference voltage generator of claim 14, wherein each of said sample and hold circuits output a moving average of the oscillating voltage.

16. The band-gap reference voltage generator of claim 11, wherein the chopped band-gap circuit comprises:
a band-gap circuit to generate a low band-gap voltage;
a modulator coupled to the band-gap circuit;
an error amplifier coupled to the modulator; and
a demodulator coupled to the error amplifier.

17. The band-gap reference voltage generator of claim 11, wherein the chopped band-gap circuit comprises an operational amplifier.

18. The band-gap reference voltage generator of claim 11, wherein the output circuit comprises an averaging circuit or a summing circuit.

19. An electronic device comprising a band-gap reference voltage generator according to claim 11.

20. An AMOLED screen comprising a band-gap reference voltage generator according to claim 11.
